(19) United States
(12) Patent Application Publication
(10) Pub. No.: US 2013/0329044 A1
(43) Pub. Date: Dec. 12, 2013

(54) ANTI-THEFT STAND INCLUDING A VIEWING SYSTEM

(71) Applicants: Jose Adan Bastos, Madrid (ES); Javier Espinosa Mejias, Madrid (ES)

(72) Inventors: Jose Adan Bastos, Madrid (ES); Javier Espinosa Mejias, Madrid (ES)

(21) Appl. No.: 13/884,654

(22) PCT Filed: Oct. 31, 2011
(86) PCT No.: PCT/ES11/00320

§ 371 Date: Aug. 30, 2013

(30) Foreign Application Priority Data
Nov. 11, 2010 (ES) P201001449

(51) Int. Cl. G08B 13/196

(52) U.S. Cl. CPC G08B 13/196
USPC 348/143

(57) ABSTRACT

The invention relates to an anti-theft stand provided with at least two diametrically opposed cameras secured to the frame in the upper central area thereof, directed towards the sides and suitably connected to an image receiving source, such as a computer, an image recorder or another similar device. The stand comprises protective panels made from transparent methacrylate with mirrored vinyl, said panels being disposed in front of the cameras and secured to the frame.

The invention relates to an anti-theft stand, also known as anti-theft antennae or arcs, which offers the truly beneficial novelty of a viewing system that effectively complements previously known devices, providing an element that considerably increases security.

These types of stands are widely used in shops, pharmacies, supermarkets, hypermarkets, shopping centres and other retail sales outlets.

Installation of such systems provides advantages that exceed the cost of the system. They have a significant deterrent effect—according to some studies, as much as 70% or 80%—whilst at the same time they allow freedom of movement for customers and encourage impulse buying. The vendor does not have to devote time to surveillance and can sell more efficiently. These systems are designed to protect against shoplifting in all types of establishments, incorporating detection systems at the cash register or at the shop exit, together with small electronic labels that can be rigid or adhesive and can be placed on the articles, either in the shop or, in the case of labelling in origin, at the manufacturing plant. These labels are disabled or removed at the point of sale. Any attempt by customers to remove or disable the label or take items out of the shop whilst the electronic alarm is still attached will set off the acoustic alarm, alerting the shop staff. However, the biggest drawback of these systems, which the proposed invention aims to resolve, is the lack of any visual record of the events. Up to now, when the alarm has been set off, the person guilty of shoplifting could leave the commercial establishment and there was no possibility of obtaining a picture of the person. If one wished to have the advantage of having imaging together with the anti-theft stand, it was necessary to acquire some kind of camera system, with the consequent costs, both in its purchase and for its installation. Furthermore, before the proposed invention, the camera systems were installed overhead or wall-mounted, which not only resulted in blind spots, but the camera distance also hampered identification of specific individuals.

This situation also increases the complexity of managing the different security measures installed.

Therefore, the proposed invention seeks to provide an economic, practical, simple and user-friendly solution that will result in savings in purchase and installation costs, time spent in system set-up and verification, and a considerable reduction in the complexity of security management, thereby facilitating security activities, given that the system provides a clear and close-up picture of shoplifters, which, in turn, reduces the possibility of thefts, and without this producing any negative effects for users, or financial, health or any other inconveniences, as well as facilitating the police's work in the case of repeating offenders with a record.

The field of application of the invention under this patent is the safety devices sector, and more specifically, that of anti-theft stands.

In the current state of technology there are few documents related to the invention in question, and none of them provide the same beneficial characteristics or effectively eliminates the existing drawbacks.

In this respect, U.S. Pat. No. 5,585,811 offers an antenna device made up of an antenna wire that crosses the receiving casing between two plates. The problem with the device in this document is the lack of any visual feedback, making it is impossible to identify the person involved in the theft.

On the other hand, U.S. Pat. No. 6,304,181 shows an anti-theft system comprising an alert signal generator—an alarm unit that is inserted into the item to be protected against theft and is made up of an electronic buzzer that is activated by means of electromagnetic waves. As in the case of the previous document, this document also leaves unresolved the problem of lack of viewing possibilities.

Another document, ES 2109515, shows an anti-theft device for use with shoes and which comprises an alarm system sensor, primary and secondary gripping or clamping plates, a screw mechanism connected to the aforementioned plates for tightening them on either side of the shoe's leather upper and other security elements. However, this invention can only be used with shoes, while the proposed invention can be used with almost any type of object.

Though the different types of security stands for commercial establishments are well known, none of them, to date, incorporate the possibility of recording images, with which these establishments are forced to invest more funds in purchasing additional security measures, entailing unnecessary expense and resulting in greater complexity.

Clearly, neither the cited documents nor the other inventions or traditional stands found in the current state of the art show any substantiation of an anti-theft stand that, due to its novel features, resolves the problems mentioned previously.

Taking into account the aforementioned cases and after analysing the conjugated arguments, the invention proposed in this document gives rise to a definitive result that provides significant differentiating aspects in respect of the current state of technology, and offers a series of advances over the currently known machines, with the corresponding advantages.

Specifically:

The system provides a means of viewing and real-time recording of the events occurring around the stands.

Better visual perspective is obtained in terms of camera angle and close-up of the observed subject's face.

No installation or maintenance of additional cameras is necessary.

Reduction in the costs of the final product in comparison to the costs involved in purchasing anti-theft stands and cameras separately.

Greater simplicity and practicality in the management of a single system instead of having to manage several systems.

Considerable increase in the deterrent effect due to the presence of cameras on the stands.

No additional space is required, given that the cameras are incorporated in the stands.

Additionally, it is easier to transport and transfer a unified system.

Consequently, this invention is made up of the following components:

A hydrophobic phenol compound rectangular base supporting a vertical wooden frame, the latter covered with an MDF (agglomerated fibreboard) housing in which the electronic circuit, duly connected to the mains, is lodged. There is an upper lid, also in MDF, underneath which there is a methacrylate panel, designed to protect the LED light and the aesthetic finish. The stand has at least two cameras mounted diametrically opposite each other, conveniently secured to the upper central part of the frame, directed towards the sides and suitably connected to an image receiving source, such as a computer a video recorder or another similar device. The stand has protective panels secured to the housing in front of the cameras, made from transparent methacrylate with mirrored vinyl.

In another version, the frame incorporates a microphone.

For better understanding of these descriptive specifications, a drawing is attached as an example but not limited thereto, describing the preferred version of the invention:

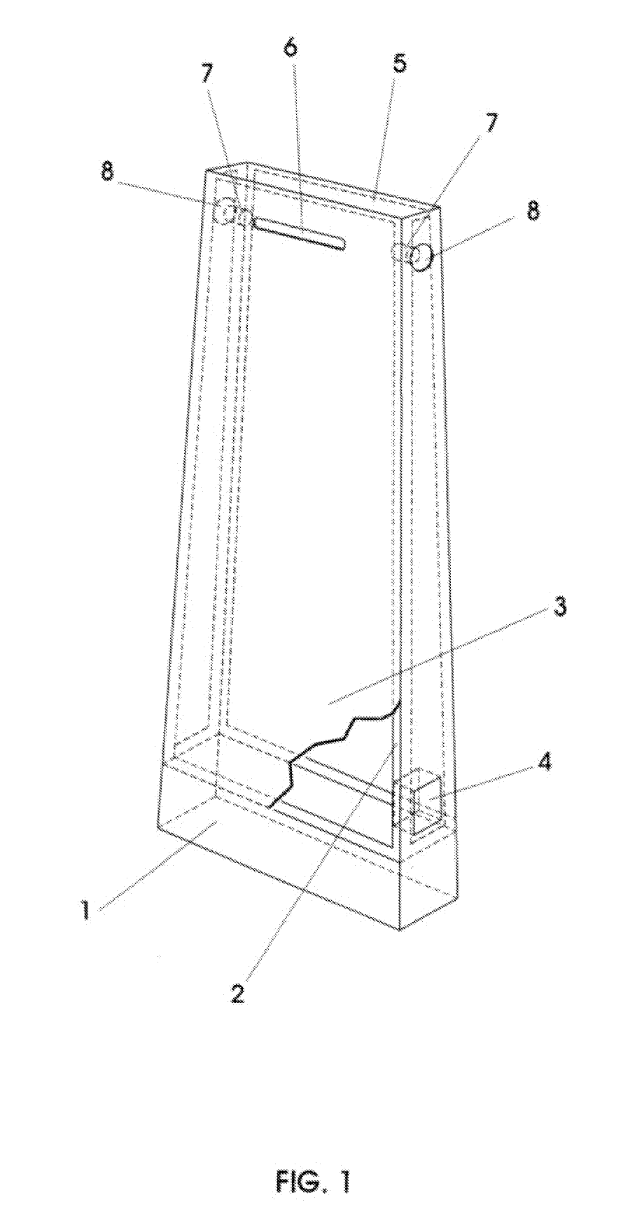

FIG. 1.

Stand perspective.

The following numbered components have been highlighted in this FIGURE.
1. Base
2. Frame
3. Housing
4. Electronic circuit
5. Lid
6. LED protector
7. Cameras
8. Protective panels

The preferred version of the proposed invention comprises the following components: A hydrophobic phenol compound rectangular base (1) supporting a vertical wooden frame (2), the latter covered with an MDF (agglomerated fibreboard) housing (3) in which the electronic circuit (4), duly connected to the mains, is lodged. There is an upper lid (5), also in MDF, underneath which there is a methacrylate panel (6), designed to protect the LED light and the aesthetic finish. The stand has at least two cameras (7) mounted diametrically opposite each other, conveniently secured to the upper central part of the frame, directed towards the sides and suitably connected to an image receiving source, such as a computer a video recorder or another similar device. The stand has protective panels (8) secured to the housing in front of the cameras, made from transparent methacrylate with mirrored vinyl.

1. ANTI-THEFT STAND INCLUDING A VIEWING SYSTEM An anti-theft stand including a viewing system, comprising a hydrophobic phenol compound rectangular base supporting a vertical wooden frame, the latter covered with an MDF (agglomerated fibreboard) housing in which the electronic circuit, duly connected to the mains, is lodged. There is an upper lid, also in MDF, underneath which there is a methacrylate panel, designed to protect the LED light and the aesthetic finish. Its characteristic feature lies in the fact that the stand has at least two cameras mounted diametrically opposite each other, conveniently secured to the upper central part of the frame, directed towards the sides and suitably connected to an image receiving source, such as a computer a video recorder or another similar device.

2. ANTI-THEFT STAND INCLUDING A VIEWING SYSTEM, pursuant to claim 1, with the characteristic feature that it has protective panels secured to the housing in front of the cameras, made from transparent methacrylate with mirrored vinyl.

3. ANTI-THEFT STAND INCLUDING A VIEWING SYSTEM, claim 1, with the characteristic feature that it has a microphone mounted on the frame.

4. ANTI-THEFT STAND INCLUDING A VIEWING SYSTEM, pursuant to claim 2, with the characteristic feature that it has a microphone mounted on the frame.
